(19) United States
(12) Patent Application Publication
(10) Pub. No.: US 2005/0085111 A1
(43) Pub. Date: Apr. 21, 2005

(54) Universal clamping apparatus and methods for connecting a ground conductor to a grounding member

(76) Inventors: Reuben E. Clark, Cary, NC (US); Gary Weise, San Juan Capistrano, CA (US)

Correspondence Address: JENKINS & WILSON, PA, 3100 TOWER BLVD, SUITE 1400, DURHAM, NC, 27707, US

(21) Appl. No.: 10/935,569

(22) Filed: Sep. 7, 2004

Related U.S. Application Data
(60) Provisional application No. 60/500,494, filed on Sep. 5, 2003.

(51) Int. Cl. H01R 4/66

(52) U.S. Cl. 439/100

(57) ABSTRACT

An apparatus for connecting a ground conductor to a grounding member includes a main body having an annular wall defining an inner region. A first portion of the annular wall defines an at least substantially C-shape and has a threaded hole defined through the wall, the threaded hole adapted to accept a threaded rod. A second portion of the annular wall opposes the first portion and defines a trough having an average radius of curvature less than an average radius of curvature of the annular wall. The trough is adapted for providing lateral support to the ground conductor. First and second legs connect ends of the first portion of the wall to corresponding ends of the second portion of the wall. Methods for connecting a ground conductor to a grounding member are also provided.

### RELATED APPLICATIONS

This application claims the benefit of U.S. Provisional Patent Application Ser. No. 60/500,494 filed Sep. 5, 2003, the disclosure of which is incorporated herein by reference in its entirety.

### BACKGROUND

This description relates to an apparatus and methods for connecting ground conductors to ground members, and more particularly to a clamping apparatus for connecting a wide range of ground conductor sizes to a wide range of grounding member sizes.

Grounding clamps have been used to electrically connect electrical devices to a grounding member, such as rebar, pipe, and ground rods, in order to provide a proper ground for the electrical devices, where typically at least a portion of the grounding members are underground. More specifically, the grounding clamp is typically fastened around the grounding member by some adjustable clamping means. An electrically conductive cable, i.e., a ground conductor, is attached to the grounding clamp by some means and also attached to a ground terminal at the electrical device, thereby providing a path for any ground currents from the electrical device through the grounding clamp down the grounding member and into the ground where it can be safely dissipated.

Many different grounding clamp designs have been disclosed in the prior art. Conventional grounding clamps, however, are limited by their design to accepting a narrow selection of grounding member sizes, and are often limited to only a single size grounding member. For example, a conventional ground clamp is typically specially designed to accommodate only a ⅝″ diameter grounding member and a limited range of ground conductor sizes. In addition, within each clamp size there are typically two or three versions of the clamp to accommodate higher torque values, e.g., heavy duty and light duty, and/or different range of ground conductor sizes.

This specialized design approach causes suppliers to stock many different sizes and duties of clamps to meet the needs of their customers, e.g., contractors. In addition, contractors have to keep different sizes and duties of clamps on hand and have to take time to investigate each project in detail to ascertain which size and duty of ground clamp is needed at each installation site in the project.

For example, U.S. Pat. No. 5,494,462 describes a ground rod clamp made for a single specific size ground rod. The clamp has an inner region distinctly defining three different constant radii circles. A first circle has the greatest radius and is for sliding the clamp over the ground rod. This radius is greater than the radius of the ground rod to allow the clamp to slide over the rod when the rod has been damaged during installation, e.g., mushroomed by repeated hammer strikes. The second circle has a radius matched to that of the ground rod to seat the ground rod snugly in place. The third circle provides a crescent shaped space below the ground rod for ground wire(s). One problem with this design is that the clamp is sized specifically for only one size ground rod. Larger sized ground rods would not fit into the second circle to connect to the ground wire(s) below. Another problem is the third circle's crescent shaped space does not provide adequate lateral support to the ground wire(s). The ground rod must fit snugly into the second circle to prevent the ground wire(s) from coming loose and sliding past the ground member. That is, if one were to try to use a smaller ground rod, the ground wire(s) could slide by the ground rod in the extra space along side the ground rod, since the crescent shape does not provide adequate support to the ground wire(s).

What is needed is a more universal clamp having a continuously tapering shape that can accommodate a variety of grounding member sizes with a wide range of ground conductor sizes while providing lateral support to a ground conductor and that can be rated for high torque use, i.e., heavy duty, to replace the many different sizes and duties of clamps currently available.

### SUMMARY

A universal clamping apparatus and methods are described that can accommodate a variety of grounding member sizes with a wide range of ground conductor sizes and can be rated for high torque use, i.e., heavy duty, to replace the many different sizes and duties of clamps currently available.

In one aspect, an apparatus for connecting a ground conductor to a grounding member includes a main body having an annular wall defining an inner region. A first portion of the annular wall defines an at least substantially C-shape and has a threaded hole defined through the wall, the threaded hole adapted to accept a threaded rod. A second portion of the annular wall opposes the first portion and defines a trough having an average radius of curvature less than an average radius of curvature of the annular wall. The trough is adapted for providing lateral support to a ground conductor. First and second legs connect ends of the first portion of the wall to corresponding ends of the second portion of the wall.

In another aspect, an apparatus for connecting a ground conductor to a grounding member includes annular wall means for defining an inner region for supporting the grounding member and ground conductor and means for accepting a threaded rod through the annular wall means to apply a compressive force to the grounding member and ground conductor. Trough means within the annular wall means support the ground member therein. The trough means has a curvature for providing lateral support to the ground member. Continuously tapering means within the annular wall means define a shape of the annular wall means that provides connection between a range of differently sized grounding members and a range of differently sized ground conductors.

In another aspect, a method for connecting a ground conductor to a grounding member includes providing a grounding apparatus having a main body comprising an annular wall defining an inner region, a first portion of the annular wall defining an at least substantially C-shape and having a threaded hole defined through the wall, the threaded hole adapted to accept a threaded rod, a second portion of the annular wall opposing the first portion and defining a trough, where the trough has an average radius of curvature less than an average radius of curvature of the annular wall and is adapted for providing lateral support to a ground conductor, and first and second legs connecting ends of the first portion of the wall to corresponding ends of the second portion of the wall. A ground member is inserted through the inner region. A ground conductor is inserted through the inner region. A threaded rod is screwed through the threaded hole to force the ground member against the ground conductor, wherein the ground conductor is securably maintained in position in the trough.

In another aspect, a method for connecting a ground conductor to a grounding member includes inserting a ground member through an inner region of a grounding apparatus, inserting a ground conductor through the inner region above a trough of the grounding apparatus, and screwing a threaded rod through a threaded hole of the grounding apparatus to force the ground member against the ground conductor, wherein the ground conductor is securably maintained in position in the trough and the trough provides lateral support to the ground conductor.

### BRIEF DESCRIPTION OF THE DRAWINGS

Objects and advantages of the described apparatus will become apparent to those skilled in the art upon reading this description in conjunction with the accompanying drawings, in which like reference numerals have been used to designate like elements, and in which:

FIG. 1 illustrates an apparatus according to one aspect;

FIG. 2 illustrates an apparatus in use according to an aspect; and

FIGS. 3-10 illustrate various combinations of grounding members and ground conductors with the apparatus.

### DETAILED DESCRIPTION

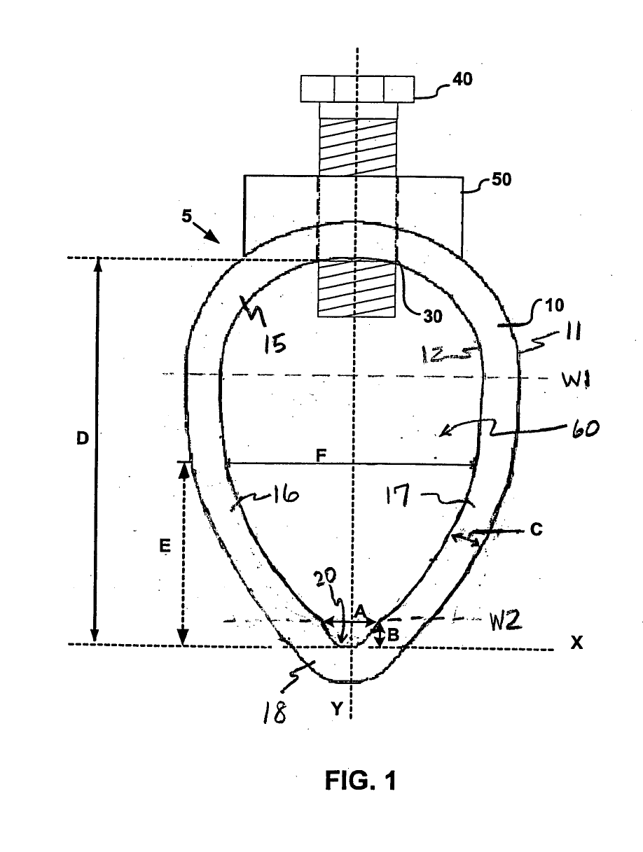

A side view of an apparatus for connecting a ground conductor to a grounding member, e.g., a ground clamp, is shown in FIG. 1. A main body 5 comprises an annular wall 10 that defines an inner region 60. The annular wall 10 includes an outer surface 11 and an inner surface 12.

The wall 10 includes a first (top) portion 15 that defines a C-shape, at least substantially, and a second portion 18 that opposes the first portion and defines a trough 20. First and second legs 16, 17 connect ends of the first portion 15 of the wall to corresponding ends of the second portion 16 of the wall from imaginary axis W1 to W2. FIG. 1 shows an example of positioning for axis W1 and W2, but other positions can be used.

The first portion 15 of the annular wall has a threaded hole 30 defined through the wall 15. The threaded hole 30 is adapted to accept a threaded rod 40, such as a bolt or screw. The threaded rod 40 preferably comprises stainless steel or bronze. The main body 5 can optionally include support block 50 in the first portion 15 to add stabilizing support around the threaded hole 30.

A threaded rod 40 can be threaded through the threaded hole 30 in a direction toward the trough 20. Here, a course or fine thread may be used, however a finer thread is preferred to provide more torque. The threaded hole 30 is preferably arranged so that a center axis Y of the threaded rod 40 is at least substantially perpendicular to a plane X including the bottom of the trough 20.

The trough 20 has an average radius of curvature that is less than an average radius of curvature of the wall 10. For example, the trough 20 can have a radius of curvature at the bottom of approximately 1.85 mm. The radius of curvature varies slightly at different points in the trough 10. In a preferred embodiment, the average radius of curvature is approximately 2 mm. The radius of curvature of the wall 10 is higher. For example, the radius of curvature around the wall can be at least 8 mm and varies. Accordingly, the average radius of curvature of the wall 10 is higher then the average radius of curvature of the trough 20.

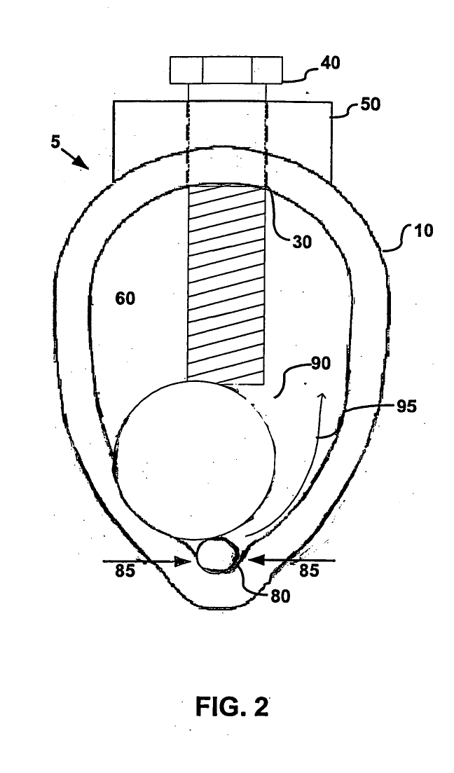

The trough 20 can be formed in the second portion 18 by the inner wall surface 12 extending further away from the first portion 15 so as to form the trough 20 and define an area or region that protrudes more outwardly in direction within the trough 20. In this way, the inner surface 12 at trough 20 can provide lateral support as discussed more specifically with reference to FIG. 2. The trough 20 can have a depth B of between 1.5 and 2 mm, and preferably approximately 1.7 mm, and a width A of between 3 and 4.5 mm, and preferably approximately 4 mm at the widest point.

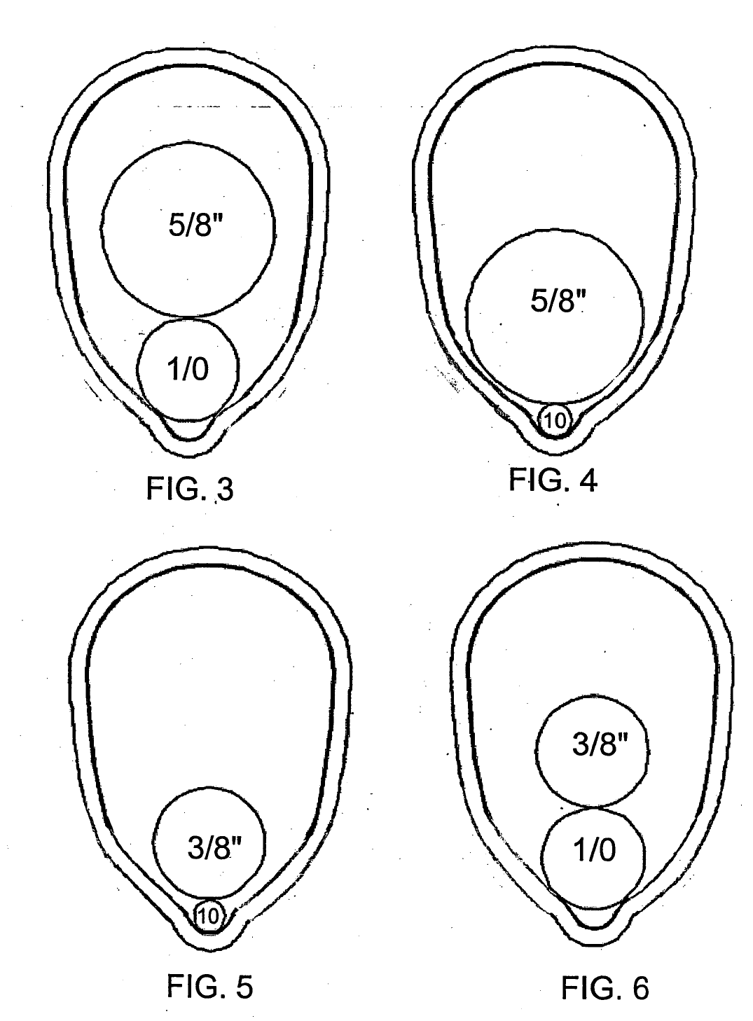

As shown in FIG. 2, a ground conductor 80 is positioned inside the trough. A grounding member 90 is positioned above the ground conductor 80 within the inner region. The threaded rod 40 is tightened through the threaded hole 30 to apply a force to the grounding member 90 and ground conductor 80 combination in cooperation with the second portion 18 of the wall, e.g., the trough. The curvature of the trough 20 provides lateral support 85 along the sides of the trough 20 for the ground conductor 80, and in particular for the smaller ground conductor 80 sizes. As shown in FIG. 2, the ground conductor 80 is prevented from sliding past the grounding member 90, as illustrated by the arrow 95, at least in part due to the lateral support 85. This is a limitation in conventional ground clamps, which lack a trough 20 that provides lateral support. The shape of trough 20 provides support to ground conductors ranging in size, as discussed more specifically with reference to FIGS. 3-10.

The first and second legs 16, 17 connect ends of the first portion 15 of the wall to corresponding ends of the second portion 16 of the wall from imaginary axis W1 to W2. In a preferred embodiment, axis W1 can be located at the widest point in the wall and W2 can be located at the beginning of the trough 20, as illustrated by FIG. 1. The first and second legs 16, 17 are continuously tapering inward from the first portion 15 of the wall, at axis W1, to the second portion 18 of the wall, at axis W2. That is, the first and second legs 16, 17 are continuously tapering inward such that the inner area continuously decreases in width in FIG. 1 to the trough 20. The use of the term “continuously tapered inward” is meant to signify that the annular wall 10 is free from any substantial inward or outward protrusions and instead defines a continuously tapering width of the inner region 60. The tapering shape helps provide connection between grounding members ranging in size and ground conductors ranging in size.

The inner surface 12 of the wall 10 can continuously taper inward along a direction curving gradually in what can be referred to as a generally concave path along each leg 16, 17. At the second portion 18, however, the inner surface 12 can change to form a slightly or generally convex surface. The inner surface 12 can then change direction once again to form the trough 20, within which the inner surface 12 can be at least generally concave.

As illustrated in FIGS. 3-10, the ground clamp is adapted to accept a wide range of grounding member sizes and a wide range of ground conductor sizes, i.e., wire gauges. In each of these figures, the grounding member 90 is shown above the ground conductor 80, with approximate relative sizes being illustrated not to scale. The sizes of the grounding member 90 are indicated in inches and the sizes of the ground conductor are indicated according to the American Wire Gauge (AWG) scale. Table 1 below lists some relative conductor diameters according to the AWG scale.

TABLE 1

| AWG | Diameter (in) | Diameter (mm) |
|---|---|---|
| #10 | 0.116 | 2.95 |
| #8 | 0.146 | 3.71 |
| #6 | 0.184 | 4.62 |
| #4 | 0.232 | 3.89 |
| #2 | 0.292 | 7.42 |
| #1 | 0.332 | 8.43 |
| #1/0 | 0.373 | 9.47 |

FIGS. 3-10 show exemplary upper and lower limits for ground conductor 80 sizes when used with each grounding member 90. For example, in FIGS. 3 and 4, a ⅝″grounding member 90 is shown with a #1/0 AWG ground conductor 80, representing the upper limit ground conductor 80, and with a #10 AWG ground conductor 80, representing the lower limit ground conductor 80. FIGS. 5-6, 7-8, and 9-10 show the upper and lower limits for ground conductor 80 sizes with a grounding member 90 of ⅜″, ½″, and ¾″, respectively. Of course working combinations include all the ground conductor 80 sizes between the exemplary limits shown.

FIGS. 3-10 illustrate the flexibility of the ground clamp in accepting a variety ground conductor and grounding member 90 sizes. In addition, Table 2 illustrates exemplary ranges of grounding member 90 and ground conductor 80 size combinations that may be secured within the inner region 60. Conventional ground clamps are limited in this regard. They are typically specially designed to fit one size grounding member only with a limited range of ground conductor sizes. The universal ground clamp described can be stocked by suppliers in place of the many different sizes and duties of clamps they must currently stock to meet the needs of their customers, e.g., contractors, thereby saving warehousing and processing costs. In addition, contractors need only keep the universal clamp on hand instead of having to keep many different sizes and duties of clamps. The contractors will also reduce the costs related to investigating each project in detail to ascertain which size and duty of ground clamp is needed at each installation site in the project, since the universal clamp can be used in most, if not all, cases.

TABLE 2

| AWG | ⅜″ | ½″ | ⅝″ | ¾″ |
|---|---|---|---|---|
| #10 | X | X | X | |
| #8 | X | X | X | X |
| #6 | X | X | X | X |
| #4 | X | X | X | X |
| #2 | X | X | X | X |
| #1 | X | X | X | X |
| #1/0 | X | X | X | X |

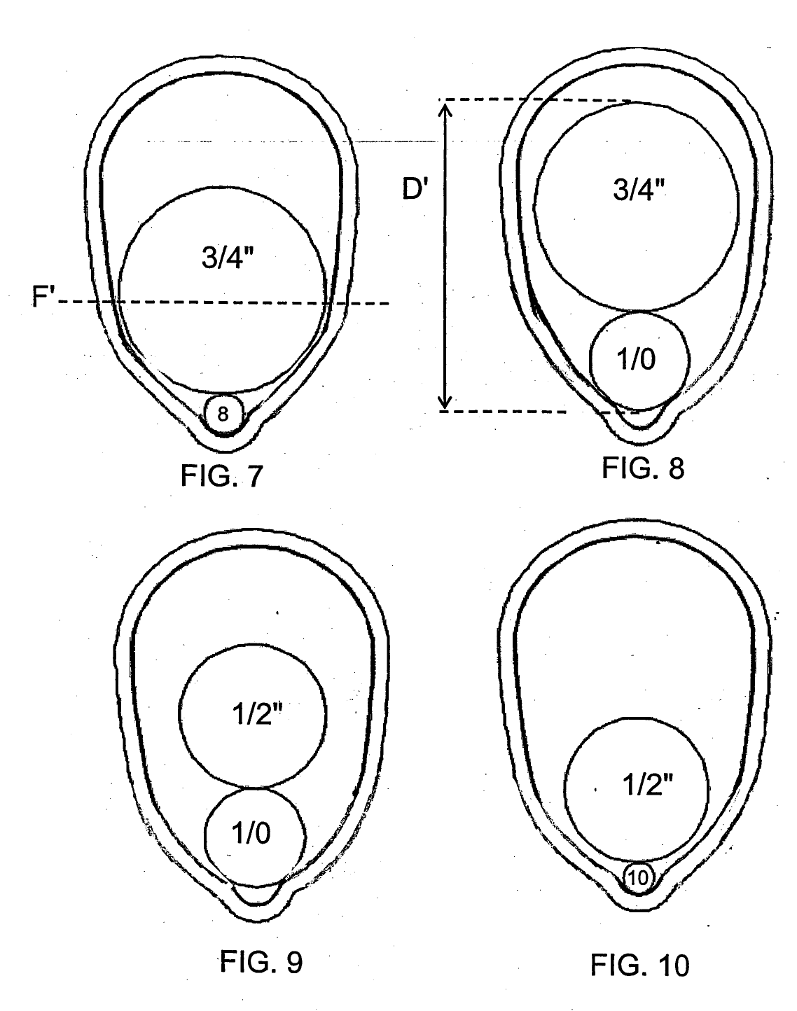

Accordingly, the main body 5 is dimensioned to accept the variety of combinations. For example, as shown in FIG. 8, the main body is large enough to accommodate a combination with a dimension D′ that is calculated as 19.05 mm (¾″)+9.47 mm (#1/0 AWG diameter)=28.52 mm. Accordingly, referring to FIG. 1, dimension D is at least 28.5 mm, such as 30 mm, to accommodate the ¾″ and #1/0 AWG combination. In FIG. 3, the main body is large enough to accommodate a combination with a dimension D′ that is calculated as 15.88 mm (⅝″)+9.47 mm (#1/0 AWG diameter)=25.35 mm. Accordingly, in this case, dimension D is at least 25.35 mm to accommodate the ⅝″ and #1/0 AWG combination. An acceptable range of values for D can therefore be 25-35 mm.

Moreover, referring again to FIG. 1, an inner dimension F taken at a distance E above the bottom of the trough is a preferred value of at least 19 mm. At this point, as illustrated in FIG. 7, a ¾″ grounding member 90 can fit along a middle axis F′ within the inner region 60 when combined with an 8 AWG conductor. The dimension F, in the example, is at least 19 mm (¾″) to accommodate the full diameter of the ¾″ grounding member 90. An acceptable range for the inner dimension F is between 19 and 23 mm. The distance E from the bottom of the trough is calculated as 19.05/2 mm (radius of ¾″ grounding member)+3.71 mm (#8 AWG diameter)=13.2 mm from a bottom of the trough.

The main body 10 can be comprised of metal alloy that comprises at least 80% copper. It will be understood, however, that other materials, including non-metallic materials, can be used to for the main body 10 in addition to or instead of a metal alloy. In a preferred embodiment, the composition of the main body 5 includes approximately 85% copper. The remaining 15% preferably includes a combination of aluminum and lead. The thickness C of the wall is preferably approximately 2.7 mm, but may be more or less. Tests have shown that this composition allows the main body 5 of the clamp to maintain structural integrity when a torquing force of up to 300 inch-pounds is applied to the threaded rod 40, which is considered a heavy duty clamp in the art. It should be appreciated that other compositions are possible and that the clamp may be made for lighter duty to save on material costs, or can be made for heavier duty such as up to 700 inch-pounds. For example, the thickness C may be less than 2.7 mm. The copper content may be 80% or more and/or other metals or non-metals may be used in the main body in combination with the copper.

During installation of the ground clamp, a method for connecting a ground conductor to a grounding member includes inserting a ground member through an inner region of a grounding apparatus, inserting a ground conductor through the inner region above a trough of the grounding apparatus, and screwing a threaded rod through a threaded hole of the grounding apparatus to force the ground member against the ground conductor. The ground conductor is securably maintained in position in the trough and the trough provides lateral support to the ground conductor.

It should be emphasized that the terms “comprises” and “comprising”, when used in this description and claims, are taken to specify the presence of stated features, steps, or components, but the use of these terms does not preclude the presence or addition of one or more other features, steps, components, or groups thereof.

It will be appreciated by those of ordinary skill in the art that the disclosed subject matter can be embodied in various specific forms without departing from its essential characteristics. The disclosed embodiments are considered in all respects to be illustrative and not restrictive. The scope of the disclosed subject matter is indicated by the appended claims, rather than the foregoing description, and all changes that come within the meaning and range of equivalents thereof are intended to be embraced thereby.

1. An apparatus for connecting a ground conductor to a grounding member, the apparatus comprising:
(a) a main body comprising:
(i) an annular wall defining an inner region,
(ii) a first portion of the annular wall defining an at least substantially C-shape and having a threaded hole defined through the wall, the threaded hole adapted to accept a threaded rod;
(iii) a second portion of the annular wall opposing the first portion and defining a trough, the trough having an average radius of curvature less than an average radius of curvature of the annular wall, the trough adapted for providing lateral support to a ground conductor; and
(iv) first and second legs connecting ends of the first portion of the wall to corresponding ends of the second portion of the wall.

2. The apparatus of claim 1, wherein the first and second legs continuously taper inward from the first portion of the wall to the second portion of the wall.

3. The apparatus of claim 1, comprising:
a threaded rod adapted to thread through the threaded hole in a direction toward the trough.

4. The apparatus of claim 3, wherein the threaded hole is arranged so that a center axis of the threaded rod is at least substantially perpendicular to a plane including a bottom of the trough.

5. The apparatus of claim 1, wherein a radius of curvature at the bottom of the trough is approximately 1.85 mm.

6. The apparatus of claim 1, wherein the trough has a depth of between 1.5 and 2 mm.

7. The apparatus of claim 6, wherein the trough depth is approximately 1.7 mm.

8. The apparatus of claim 1, wherein the trough has a width of between 3 and 4.5 mm at a widest point.

9. The apparatus of claim 8, wherein the trough width is approximately 4 mm at the widest point.

10. The apparatus of claim 1, wherein the main body has an inner dimension of at least 28.5 mm from a bottom of the trough to the threaded hole.

11. The apparatus of claim 1, wherein the main body has an inner dimension of between 25 and 35 mm from a bottom of the trough to the threaded hole.

12. The apparatus of claim 11, wherein the inner dimension is approximately 30 mm.

13. The apparatus of claim 1, wherein the main body has an inner dimension of at least 19 mm across a plane parallel to an axis extending from the bottom of the trough through a center of the threaded hole and 13.2 mm from a bottom of the trough.

14. The apparatus of claim 13, wherein the inner dimension is between 19 and 23 mm.

15. The apparatus of claim 1, wherein the main body comprises a metal alloy comprising at least 80% copper.

16. The apparatus of claim 1, wherein the main body comprises a metal alloy comprising approximately 85% copper.

17. The apparatus of claim 1, wherein the main body comprises a metal alloy comprising copper, aluminum, and lead.

18. The apparatus of claim 1, wherein the main body maintains structural integrity when a torquing force of up to 300 inch-pounds is applied to a threaded rod threaded through the threaded hole and is pressing, at least indirectly, against the trough.

19. The apparatus of claim 1, wherein the main body is configured to accept, within the inner region, grounding members ranging in size from ⅜ to ¾ inches.

20. The apparatus of claim 1, wherein the inner region is configured to accept grounding members ranging in size from ⅜ to ¾ inches simultaneously with ground conductors ranging in size from #10 to #1/0 American wire gauge (AWG).

21. An apparatus for connecting a ground conductor to a grounding member, the apparatus comprising:
(a) annular wall means for defining an inner region for supporting the grounding member and ground conductor;
(b) means for accepting a threaded rod through the annular wall means to apply a compressive force to the grounding member and ground conductor;
(c) trough means within the annular wall means for supporting the ground conductor therein, the trough means having a curvature for providing lateral support to the ground member; and
(d) continuously tapering means within the annular wall means for defining a shape of the annular wall means that provides connection between a range of differently sized grounding members and a range of differently sized ground conductors.

22. The apparatus of claim 21, wherein the tapering means defining a shape of the annular wall means is configured to provide connection between grounding members ranging in size from ⅜ to ¾ inches and ground conductors ranging in size from #10 to #1/0 AWG.

23. A method for connecting a ground conductor to a grounding member, the method comprising:
(a) providing a grounding apparatus having a main body comprising:
(i) an annular wall defining an inner region,
(ii) a first portion of the annular wall defining an at least substantially C-shape and having a threaded hole defined through the wall, the threaded hole adapted to accept a threaded rod;
(iii) a second portion of the annular wall opposing the first portion and defining a trough, the trough having an average radius of curvature less than an average radius of curvature of the annular wall, the trough adapted for providing lateral support to a ground conductor; and
(iv) first and second legs connecting ends of the first portion of the wall to corresponding ends of the second portion of the wall;
(b) inserting a ground member through the inner region;
(c) inserting a ground conductor through the inner region; and
(d) screwing a threaded rod through the threaded hole to force the ground member against the ground conductor, wherein the ground conductor is securably maintained in position in the trough.

24. A method for connecting a ground conductor to a grounding member, the method comprising:
(a) inserting a ground member through an inner region of a grounding apparatus;
(b) inserting a ground conductor through the inner region above a trough of the grounding apparatus; and
(c) screwing a threaded rod through a threaded hole of the grounding apparatus to force the ground member against the ground conductor, wherein the ground conductor is securably maintained in position in the trough, the trough providing lateral support to the ground conductor.
